(19) United States
(12) Patent Application Publication
(10) Pub. No.: US 2004/0038174 A1
(43) Pub. Date: Feb. 26, 2004

(54) Applicator for liquid dental materials

(75) Inventors: Cornelis Pameijer, Simsbury, CT (US); Steven R. Jefferies, York, PA (US); Kenneth S. Peterson, (US)

Correspondence Address: DENTSPLY INTERNATIONAL INC, 570 WEST COLLEGE AVENUE, YORK, PA, 17404

(73) Assignee: DENTSPLY Research & Development Corp.

(21) Appl. No.: 10/270,464

(22) Filed: Oct. 15, 2002

Related U.S. Application Data
(63) Continuation of application No. 10/226,974, filed on Aug. 25, 2002.

(51) Int. Cl. A61C 5/04

(52) U.S. Cl. 433/90; 433/89

(57) ABSTRACT

The specification describes an applicator for the treatment of teeth with small amounts of dental materials, such as polymerizable sealants and adhesives, prophylactic treatment materials and the like. The applicator is in the form of a disposable tube having an applicator brush at one end. The tube is fitted to an applicator head that facilitates drawing an amount of the material into the tube and the selected filling of the brush. The applicator may include an elongated member having an applicator head that contains a chamber enclosing a similarly-shaped resilient member. A closure fits over the end of the applicator head and serves to close off the base of the chamber and seal the peripheral edge of the resilient member to prevent leakage. The closure is provided with a smaller chamber which communicates with a channel extending out through the closure and adapted to receive the disposable tube. The channel is positioned at an angle to the main body of the applicator. The applicator is provided with a movable lever-operated piston that presses on the resilient member for drawing liquid into and dispensing liquid from a disposable tube after the same has been inserted into the applicator head.

### TECHNICAL FIELD

The present invention is directed toward a device to apply relatively small amounts of liquid or flowable dental materials to dentition. More particularly, the invention provides for the precise loading of a brush with the material to be applied. The invention provides an applicator tube having the brush at one end, and a device to draw an amount of material into the tube, and to selectively dispense amounts of material from the tube, thereby selectively loading the brush. Thus loaded, the brush can be used to apply the dental material to a desired location on the dentition.

### BACKGROUND OF THE INVENTION

There has been increasing interest in the treatment of teeth with fluid polymerizable monomers, which are activated to form on the tooth surface, after curing, a strongly adherent protective polymer film coating. Pit and fissure sealants, adhesives and the like, often require the precise application of small amounts of such materials. One method of achieving the desired result has been to provide a reservoir of the material, and to repeatedly dip a brush into the reservoir to load the brush. A drawback with this technique is that repeated dipping is often necessary for a given dental procedure, thereby increasing not only the time involved but also the risk of contamination to the reservoir of material. It has been the practice to use multiple brushes that are dipped once and then discarded. Multiple brushes are often required for even relatively small applications of material.

As stated, it has generally been the practice to apply monomeric materials with a brush or spatula to the tooth surface, the polymerizable fluid wetting the surface and tending to flow over the same. Such treatment is awkward at best for the treatment of the upper teeth as the polymerizable monomer, particularly if in a thin fluid state, has a tendency to flow down the applicator making it difficult to apply controlled amounts to the tooth area being treated.

It has heretofore been proposed to use a syringe for applying dental varnishes as shown, for example, in U.S. Pat. No. 2,142,780. However, where the material to be applied has been activated, for example, as the pit and fissure-treating compositions described in U.S. Pat. No. 3,663,501, the activated treating composition remaining in the dispenser would polymerize thus making it necessary to discard the same. As the setting time for such composition, after being activated, is generally in the order of about 5 minutes or less it is apparent that there would not be sufficient time to clean all remaining activated treating composition from a syringe prior to its polymerization.

It has been observed that the best coating of the teeth is obtained when the treating monomer is highly fluid and readily wets the surface of the tooth so as to rapidly flow out over the surface in a thin film. For such treatment it is not only important to carefully position the monomeric coating material on the tooth area to be treated but also to place the coating composition on the tooth in a precise manner so that only small quantities are used.

It has also been suggested to employ applicators for dental materials, wherein a small amount of material is drawn into a tube, such as in U.S. Pat. No. 4,043,042, which is hereby incorporated by reference for such disclosure.

### SUMMARY OF THE INVENTION

In accordance with the present invention a dispensing applicator is designed which enables the operator to load a brush with a liquid dental material in a controlled manner on either upper or lower teeth without worry of the activated monomer flowing down the instrument during application. Also, the activated monomer cannot polymerize in the instrument so as to deleteriously effect its operation or reuse. Also, the applicator of the present invention is so designed as to enable the dentist or dental assistant to accurately place a small controlled amount of activated monomer on a tooth surface regardless of its location in the mouth. The applicator of the invention allows for repeated loading of the brush with the material that has been previously drawn into the tube, thereby allowing a complete dental procedure to be performed, often with only one initial dipping of the applicator tube into the supply or storage reservoir of the dental material.

The applicator of the present invention is in the form of an elongated member having an applicator head and operating mechanism at one end with the remainder of the elongated member serving as a handle to be grasped by the dentist. A disposable tip or tube, through which the coating composition is applied, is removably carried by the applicator head and projects at an angle with respect to the handle for ease of application. The tube has a brush at one end, namely the output end.

An exemplary applicator head contains a semi-spherical chamber which opens into a relatively short longitudinal first bore contained in the handle portion immediately adjacent to the applicator head. A simultaneously shaped member, such as a cupped resilient diaphram, is positioned in the chamber the diaphragm being of such size and shape that its outer surface is adjacent to and preferably contacts the inner surface of the semi-circular chamber.

A closure member positioned on the end of the applicator serves to close the base portion of this first semi-spherical chamber and hold and seal the outer edge of the resilient member. The closure contains a smaller second chamber which is in direct alignment with the longitudinal bore contained in the handle and contains a second bore of somewhat smaller diameter which extends at an angle to the longitudinal axis of the applicator. This second bore extends through the cover and is in direct communication with the second chamber. This second bore contained in the closure member is adapted to receive a disposable tube which is the applicator tip into which treating compositions are drawn and from which applied to the teeth.

The first bore, which is located in the handle portion adjacent applicator head, contains a piston which is adapted to move longitudinally within this first bore and press against the resilient member for compressing the same. An angular-operating lever is pivotally secured on top of the applicator with one leg of the lever extending rearwardly on top of the applicator and essentially paralleling the same with the other leg of the lever extending into the first bore of the applicator and adapted to press on one end of the piston for actuating the same.

When the applicator is to be used, a disposable tube is inserted into the end of the second bore in the applicator head. Pressure is then applied on the exposed leg of the angular-operating lever. This causes the piston to be pushed forward where it presses against the resilient member and expresses air from the semi-spherical chamber. The applicator is then immersed in the activated monomer with which the tooth is to be treated and pressure on the exposed leg of the lever is released. The semi-spherical resilient diaphragm then retains its initial form with the result that a partial vacuum is created and air is drawn into the semi-spherical chamber and the liquid up into the disposable tube. The size of the semi-spherical chamber, the distance of movement of the piston, and the diameter and length of the disposable tube are related to each other so that the change in volume in the semi-spherical chamber on movement of the piston is such that only a few drops of liquid are drawn into the disposable tube the amount never being such that the disposable tube will fill and liquid flow into the second chamber inside the closure. At this point, the lever can again be depressed, causing an amount of material to flow back out of the tube, to thereby fill or load the brush. The user can them manipulate the applicator such that the brush is used to apply or “paint” the dental material to the desired location. When the material is thereby applied, the lever can again be depressed, again loading the brush for another application. The process can be repeated as many times as necessary and as long as material remains in the tube. Preferably, one filling of the tube will provide enough material for a plurality of brush loading operations.

### BRIEF DESCRIPTION OF THE DRAWINGS

FIG. 1 is a side view of the applicator.

FIG. 2 is a cross-sectional view of the applicator of FIG. 1.

FIG. 3 is another cross-sectional view of the applicator of FIG. 1.

FIG. 4 is a perspective view of the applicator of FIG. 1, shown for environmental purposes in the hand of a user.

FIG. 5 is a perspective view of the applicator tube portion of the applicator of FIG. 1, shown as having been manufactured from a clear material and showing an applicator brush affixed thereto.

FIG. 6 is an alternative embodiment of the tube of FIG. 5.

FIG. 7 is an additional alternative embodiment of the tube of FIG. 5.

FIG. 8 is a further alternative embodiment of the tube of FIG. 5.

FIG. 9 is a still further alternative embodiment of the tube of FIG. 5.

FIG. 10 is another alternative embodiment of the tube of FIG. 5.

FIG. 11 is another alternative embodiment of the tube of FIG. 5.

### PREFERRED EMBODIMENTS FOR CARRYING OUT THE INVENTION

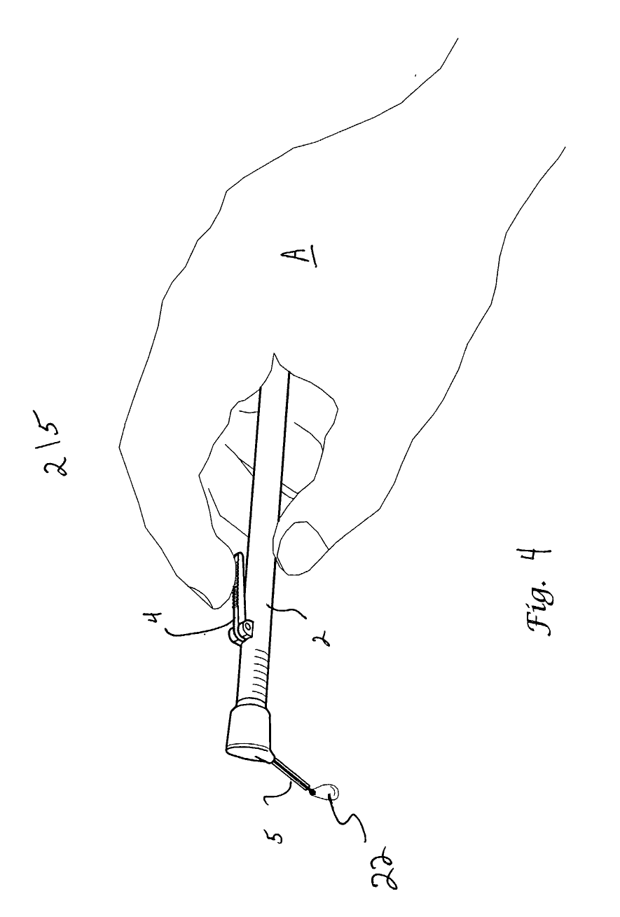

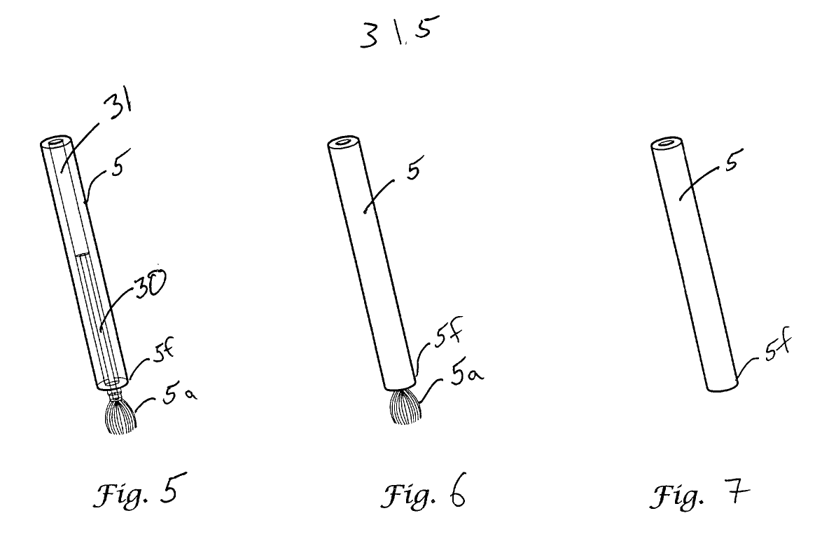

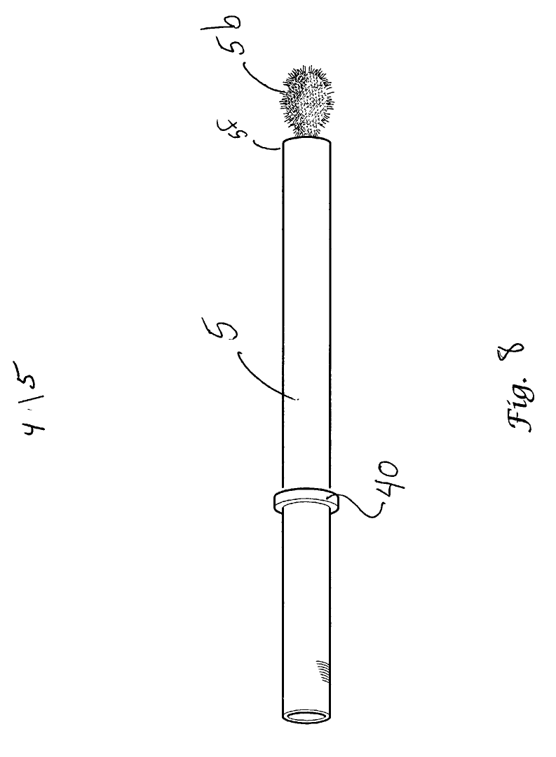

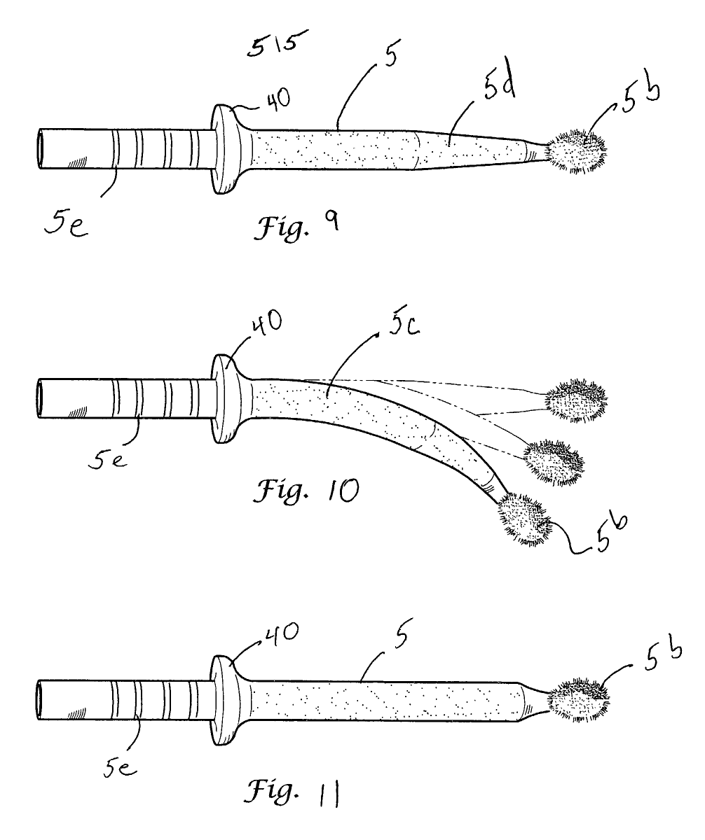

Referring to the drawings, an exemplary applicator 1, is in the form of an elongated member a substantial part of the same forming the handle 2, which would be grasped by the user A. This is illustrated in FIG. 4. The front part of the applicator contains the applicator head 3, the operating lever 4, and the disposable tube 5, having a brush 5a at one end thereof.

Tube 5 having brush 5a may be used with any type of applicator capable of facilitating drawing an amount of material into tube 5 and to dispense it therefrom, hereby loading brush 5a. Further, the applicator should be capable of drawing an amount of the material into tube 5 and then selectively dispensing only a part of the total amount of the material originally drawn into tube 5. In this way, multiple and repeated loadings of brush 5a, preferably at least two, can be made without reentry of the tube 5 into a storage reservoir (not shown) of the material to be applied.

Brush 5a can be any type of brush suitable for dental use, such as those fabricated from natural or synthetic materials. The brush materials may be applied onto the tube 5 in any conventional fashion, such as by flocking or the like. Tube 5 may be fabricated from any material, but is preferably a clear plastic, such that a user can see within tube 5, as illustrated in FIG. 5. Of course, any material including opaque materials or the like may be employed, as is illustrated in FIG. 6.

An exemplary applicator is shown in the drawings, it being understood that any applicator capable of functioning to draw and dispense material into and from tube 5 is within the scope of the invention. Referring to FIGS. 2 and 3, the end of the exemplary applicator, forming the applicator head, is enlarged as illustrated at 3 to form a semi-spherical first chamber 6. Communicating with this chamber is a first bore 7 containing a piston 8 which is moved by depression of the operating lever 4 so as to press against resilient member 9. The cylindrical member forming piston 8 preferably has an outside diameter of this first bore 7. Also, lever 4, piston 7 and resilient member 9 are all preferably positioned one with respect to the other so that the piston 8 has slight pressure thereon from the resilient member 9 when the operating lever 4 is not being operated as is shown in FIG. 2. When operated an immediate flexing of the resilient member 9 will take place, as will become more clear from the following discussion.

In chamber 6 is positioned a resilient member 9, such as a cupped resilient diaphragm, whose outside dimensions are essentially the same as the inside dimensions of chamber 6 so that the outer surface of the diaphragm 9 is preferably in contact with the inner surface of chamber 6.

The end of chamber 6 is closed by a closure 10 which is secured to the enlarged portion of the applicator head 3 by means of a flange 11 extending from the end of enlarged portion 5 and adapted to fit snugly into a groove 12 provided in the closure 10. The outer periphery 13 of the semi-spherical resilient member 9 is held in sealed position in the recess 14 formed between the inner surface of the enlarged portion of the applicator head 3 and the closure 10.

A second bore or chamber 16 extends downwardly from chamber 6 with which it is in fluid communication, through closure 10 preferably at a substantial angle to the longitudinal axis of the applicator and is adapted to have the disposable tube 5 inserted therein prior to use of the applicator. Tube 5 is therefore, also in fluid communication with chamber 6. The outer end 17 of bore 16 may be beveled to aid in the insertion of disposable tube 5. In order to avoid an inserted disposable tube 5 from entering chamber 6 the inner diameter of the second bore 16 may be reduced at end 23 so as to provide a stop for the disposable tube 5. When received within bore 16, tube 5 has an end 5f distal to end 17.

The operating lever 4 is an angular member pivotally attached at 18 with one leg 19 extending outside of the applicator lengthwise of the same and another other leg 20 extends down into the bore 7. Leg 19 is raised from the surface of the applicator so that the same can be depressed.

When leg 19 of lever 4 is pressed, lever 4 will pivot around pivot 18 with the leg 20 of lever 4 moving forward. The forward movement of leg 20 causes piston 8 to be pushed along bore 7 and press against the outer periphery of the resilient diaphragm 9 (FIG. 3). In the preferred embodiment the legs 19 and 20 of the lever are of such length and so disposed with respect to each other that substantial finger movement for operating the lever is required for slight forward movement to be transmitted to the piston, this movement generally being on a ratio of about two to one.

The purpose of using the piston 8 for pressing on the diaphragm 9 rather than having the leg 20 press directly thereon is that through use of the piston 8 a substantially more controlled and uniform pressure can be obtained. Also, the reason for having the resilient diaphragm 9 fit snugly within the semi-spherical chamber 6 is to obtain more uniform action. Uniform action is important as the device is designed for applying small controlled amounts of material in a uniform manner. To further facilitate such expression, piston 8 may be pointed at its end 8a that is in physical contact with diaphragm 9.

In use, the dentist or dental assistant will insert a disposable tube 5, from a quantity made available, into opening 17. He will then prepare the treating composition which, if a pit and fissure sealant for example, will be a catalyzed monomer or monomer mix which will polymerize after a few minutes depending on the particular set time for the material used. The dentist or dental assistant would then depress lever 4, place the exposed end or tip 21 of the disposable tube 5 in the prepared composition, release pressure on lever 4. In this manner, an amount of the material will be drawn into tube 5. By again depressing lever 4, an amount of material is caused to be expressed from tube 5, to thereby load brush 5a with the material. The brush 5a can then be used to apply the material to a tooth to be treated. By thereby depressing lever 4 a small amount 22 (FIG. 4) of the treating composition would be forced out through tip 5, to thereby load brush 5a. This process can be repeated as necessary or desired, and as long as material remains in tube 5.

The internal diameter of disposable tube 5 is relatively small as the applicator is designed for applying small controlled quantities of fluid, but is large enough to facilitate at least two and preferably more, loadings of brush 5a and application of the material to the desired location.

It may also optionally be that the movement of the piston 8 with respect to the diaphragm 9 is adjusted so that the partial vacuum created when the pressure of lever 4 on piston 8 is released and the diaphragm permitted to return to its original position (that is, from the position shown in FIG. 3 to the position shown in FIG. 2), is such that the volume of fluid drawn into the disposable tube 5 is insufficient to completely fill the tube. Thus, any spilling of the treated fluid into the chamber 6 is avoided. After treatment, the dentist or dental assistant would then remove the disposable tube 5 and discard the same. A new tube 5 would then be inserted into the applicator head 3 prior to further use. It is thus apparent that none of the treating composition would remain in the applicator, and any problems resulting from polymerization of the treating composition in the applicator is thus avoided

In one preferred embodiment of the applicator the space within the chamber 6 formed by head 3 and resilient member 9 has a volume of about 0.0297 cubic inches. The disposable tubes used are of ¾ or ⅝ inch in length and have inside diameters of 0.062 and 0.0018 inches respectively. Thus, the inside volume of the ¾ inch tube is 0.0023 cubic inch and that of the ⅝ inch tube 0.0018 cubic inch.

The movement of the piston 8 on depression of the operating lever 4 is adjusted so as to only partially fill the disposable tube with treating liquid on release of the operating lever. Of course, if desired, all of tube 5 and even chamber 6 could be filled.

In a further embodiment of the invention as shown in FIG. 5, a secondary tube 30 is located within tube 5, and has a smaller internal diameter than tube 5 (FIG. 4). Secondary tube 30 thereby serves to restrict the internal diameter of tube 5. In this way, material contained within tube 5 is less likely to spill out of tube 5, due to surface tension, until selectively expressed therefrom by movement of lever 4. Preferably, secondary tube 30 has a length less than the length of tube 5, such that an amount of material is held within tube 5 in the area 31 where secondary tube 30 does not extend. This area 31 thus serves as a temporary reservoir for the dental material (shown as drop 22 in FIG. 4), further facilitating the repeated loading of brush 5a as was above discussed.

It will be appreciated that a tube 5 having a secondary tube 30 may be useful with or without brush 5a thereon. Therefore, such a tube 5 with or without secondary tube 30 and with or without a brush 5a is equally within the scope of the present invention, as shown in FIG. 7. Use of secondary tube 30 is particularly advantageous when a brush 5a is not disposed upon tube 5, but is also advantageous when it is so disposed.

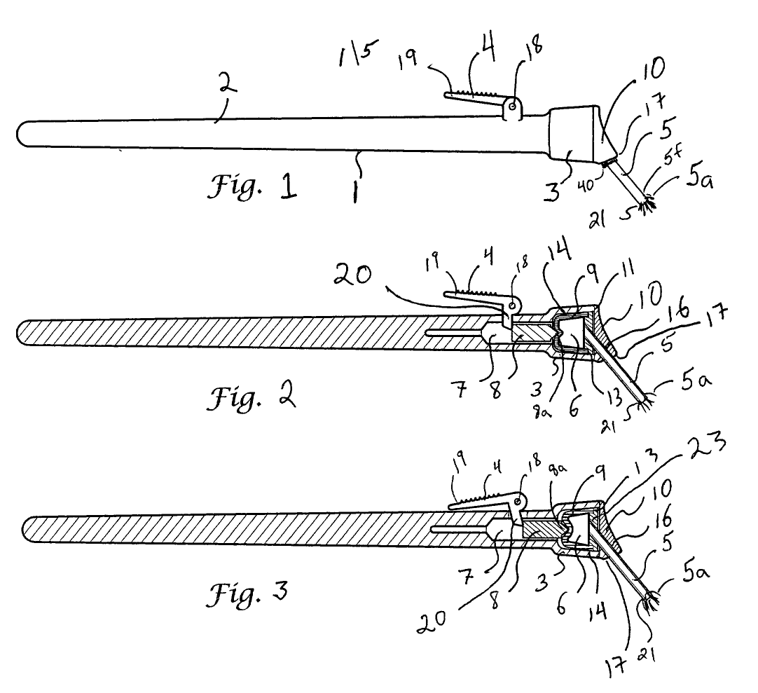

FIG. 8 depicts an alternative embodiment of the invention, wherein tube 5 is provided at some preselected midpoint with a shoulder 40. As will be appreciated, by selecting the size, shape and/or diameter of shoulder 40, shoulder 40 can be made to physically contact and abut outer end 17 of bore 16, thereby effectively limiting the placement of tube 5 within bore 16 and its location with respect to chamber 6 (FIG. 1).

As shown in FIGS. 9-11, shoulder 40 may also be contoured in shape. More preferably, the size of shoulder 40 is selected such that it is slightly larger than the size of outer end 17, such that a user can grasp shoulder 40 to facilitate the tube 6 placement into or removal from head 3.

Further still, tube 5 may be fabricated from a material, preferably a plastic material, such that it is flexible, with or without memory of its original shape. A flexible tube 5 is depicted in FIG. 10, wherein a forward portion 5c is shown schematically as being flexed.

FIGS. 8-11 also depict a flocculant brush 5b as an alternative embodiment of bristle brush 5a. Bristle brush 5a is made of a plurality of similarly arranged bristles. Flocculant 5b is made of a plurality of flocculant fibers arranged in any manner desired.

Tube 5 may also have tapered or reduced diameter portions 5d to further facilitate manipulation by the user. Tube 5 may also have ridges 5e at a rear portion thereof, such that ridges 5e serve to increase friction between tube 5 and bore 16 to improve the fluid seal between tube 5 and bore 16, and also to help retain tube 5 within bore 16.

Although the applicator 10 has been described for use primarily with pit and fissure sealants and adhesives, the same may be used for applying other treating materials to tooth surfaces, such as prophylactic materials and the like. The particular construction described enables the exemplary applicator head to be relatively small in size while still obtaining controlled and efficient operation with the actuator lever being in position for convenient and efficient control by the operator. Also, the angular position of the disposable tube with respect to the remainder of the applicator, the positioning of the operating lever with respect to the applicator head and the relatively small dimensions of the applicator head all enable the operator to work in the patient's mouth in any position and obtain excellent access to otherwise difficult tooth areas.

What is claimed is:

1. An applicator for dispensing a small amount of a fluid onto a surface comprising:
an elongated member,
a first bore formed in the forward end of said elongated member,
a chamber formed in the forward end of said elongated member and in direct communication with said first bore,
a resilient diaphragm positioned in said first chamber,
movable means in said first bore positioned with respect to said resilient diaphragm as to maintain positive pressure thereon,
a closure for said chamber,
a second bore in said closure said second bore extending from said chamber and adapted to receive a disposable tube insertable therein, and
operating means for moving said movable means towards said resilient diaphragm to increase the pressure thereon and expel air from said chamber, the relative size of said chamber and the distance of movement of said movable means is such that the change in volume of the chamber on movement of the movable means away from said resilient diaphragm is such that an amount of liquid may be drawn into said tube;
said tube having a brush at an end thereof distal to said chamber when said tube is received within said second bore.

2. An applicator as in claim 1, wherein said brush is made of a plurality of bristles.

3. An applicator as in claim 1, wherein said brush is made of a plurality of flocculant fibers.

4. An applicator for dispensing a small amount of a fluid onto a surface comprising:
an elongated member,
a first bore formed in the forward end of said elongated member,
a chamber formed in the forward end of said elongated member and in direct communication with said first bore,
a resilient diaphragm positioned in said first chamber,
movable means in said first bore positioned with respect to said resilient diaphragm as to maintain positive pressure thereon,
a closure for said chamber,
a second bore in said closure said second bore extending from said chamber and adapted to receive a disposable tube insertable therein, and
operating means for moving said movable means towards said resilient diaphragm to increase the pressure thereon and expel air from said chamber, the relative size of said chamber and the distance of movement of said movable means is such that the change in volume of the chamber on movement of the movable means away from said resilient diaphragm is such that an amount of liquid may be drawn into said tube;
said tube having a shoulder such that said shoulder physically contacts an outer portion of said second bore, thereby limiting the placement of said tube within said second bore.

5. An applicator as in claim 4, wherein said shoulder is physically larger in dimension than said outer portion of said second bore.

6. An applicator for dispensing a small amount of a fluid onto a surface comprising:
an elongated member,
a first bore formed in the forward end of said elongated member,
a chamber formed in the forward end of said elongated member and in direct communication with said first bore,
a resilient diaphragm positioned in said first chamber,
movable means in said first bore positioned with respect to said resilient diaphragm as to maintain positive pressure thereon,
a closure for said chamber,
a second bore in said closure said second bore extending from said chamber and adapted to receive a disposable tube insertable therein, and
operating means for moving said movable means towards said resilient diaphragm to increase the pressure thereon and expel air from said chamber, the relative size of said chamber and the distance of movement of said movable means is such that the change in volume of the chamber on movement of the movable means away from said resilient diaphragm is such that an amount of liquid may be drawn into said tube;
said tube being formed of a flexible material.

7. An applicator for dispensing a small amount of a fluid onto a surface comprising:
an elongated member,
a first bore formed in the forward end of said elongated member,
a chamber formed in the forward end of said elongated member and in direct communication with said first bore,
a resilient diaphragm positioned in said first chamber,
movable means in said first bore positioned with respect to said resilient diaphragm as to maintain positive pressure thereon,
a closure for said chamber,
a second bore in said closure said second bore extending from said chamber and adapted to receive a disposable tube insertable therein, and
operating means for moving said movable means towards said resilient diaphragm to increase the pressure thereon and expel air from said chamber, the relative size of said chamber and the distance of movement of said movable means is such that the change in volume of the chamber on movement of the movable means away from said resilient diaphragm is such that an amount of liquid may be drawn into said tube;
said tube having a second tube axially disposed within said tube, said second tube having a lengthwise dimension less than the lengthwise dimension of said tube.
